(19) United States
(12) Patent Application Publication
(10) Pub. No.: US 2009/0265314 A1
(43) Pub. Date: Oct. 22, 2009

(54) SECURE FILE SEARCHING

(75) Inventors: Uwe Kindsvogel, Zeutern (DE); Klaus Irle, Waldorf (DE); Juergen Pravez, Bruchsal (DE); Stefan Haas, Kraichtal (DE); Andreas Kellner, Birkenau-Loehrbach (DE); Carsten Mueller, Mannheim (DE)

Correspondence Address: SCHWEGMAN, LUNDBERG & WOESSNER/SAP, P.O. BOX 2938, MINNEAPOLIS, MN, 55402, US

(73) Assignee: SAP AGDietmar-Hopp-Allee

(21) Appl. No.: 12/106,025

(22) Filed: Apr. 18, 2008

(51) Int. Cl. G06F 17/30

(52) U.S. Cl. 707/3; 707/9; 707/E17.017; 707/E17.01

(57) ABSTRACT

Apparatus, systems, and methods are disclosed that operate to receive file search criteria and at least one security identifier, each associated with a user identity. Operations include identifying a set of authorized files as an intersection between a first group of files meeting the file search criteria and a second group of files, wherein each one of the second group of files is associated with a previously-resolved list of security identifiers that includes the security identifier associated with the user identity. Additional apparatus, systems, and methods are disclosed.

### BACKGROUND

Information, available in the form of electronic content, is created, stored, and accessed by individuals on a regular basis. While some of this information (e.g., public information, such as a weather forecast) is intended for use by the general public, much of it (e.g., private information, such as individual bank accounts) is not.

As the amount of available information increases, the desire to search efficiently within the information also grows. However, search efficiency may actually decrease, due to the growing amount of information combined with the constraints imposed by privacy concerns.

### BRIEF DESCRIPTION OF THE DRAWINGS

FIG. 1 illustrates the process of security identifier (SID) resolution for users executing secure file searching within a group hierarchy according to various embodiments of the invention.

FIG. 2 illustrates the process of security identifier (SID) resolution for files in a file system according to various embodiments of the invention.

FIG. 3 is a block diagram of an apparatus and system to implement secure file searching according to various embodiments of the invention.

FIG. 4 is a flow diagram illustrating methods of secure file searching according to various embodiments of the invention.

FIG. 5 is a flow diagram illustrating additional methods of secure file searching according to various embodiments of the invention.

FIG. 6 is a block diagram of a machine in the example form of a computer system according to various embodiments of the invention.

### DETAILED DESCRIPTION

While web search engines generally access public files, search engines that operate on files within an enterprise typically implement security to limit access to private information. The inventors have discovered that the challenges noted above, as well as others, can be addressed using a mechanism that implements secure file searching to ensure that a user performing a search only sees files in the search result list for which access has been pre-approved. In order to provide full text search for private files in an efficient manner, the file system is crawled prior to the search and the files are replicated to the search engine. Access rights associated with granting access to files for various users are then stored within the file system. When the enterprise search engine is used to search these files, the access rights are considered within the context of each search.

For the purposes of this document, the following definitions will be observed:

An “attribute” is a property of an entity.

A “desktop” or “electronic desktop” comprises a graphical user interface that displays icons representing programs, folders, files, and various types of other electronic content (e.g., documents, letters, reports, pictures). The icons on an electronic desktop can be arranged in the same way as real objects are arranged on the top of a real desk—by moving them around, putting one on top of another, reshuffling them, and throwing them away.

A “domain” is the type or value range of an attribute.

An “entity” is a physical object or concept, such as a user, a customer, a product, or a file.

“Private information” is information that has some security designation applied to it so that access can be limited to a designated audience. For example, private information may be maintained as such with respect to an enterprise, a set of groups, a group, and even with respect to an individual user.

“Public information” is information for which access is not controlled, at least with respect to a designated audience. For example, information may be designated as public information with respect to a network, an enterprise, or a group.

A “user” is a human being that makes use of a desktop to access public and private information.

Various embodiments of the invention can be viewed from a variety of perspectives. For example, from the user's perspective, a user can be a member of an authorization group, and an authorization group can be a member of other authorization groups. Uniform Security Identifiers (SIDs) may be used to represent users and authorization groups that have access to private information when searches are performed.

The perspective of an individual file is based on the directory in which the file is located. The directories of a file system form a hierarchy where SID lists are assigned to files and directories. Therefore, a file in the file system may have a direct or indirect assignment to a list of SIDs. If no direct assignment of an SID is made to a file, indirect assignments to the file from further up in the directory hierarchy can be resolved to one or more direct assignments. While crawling the file system, an enterprise search engine (e.g., the TREX search and classification engine that forms a part of the SAP NetWeaver® integrated technology platform, available from SAP AG of Walldorf, Germany) can acquire the resolved (materialized) SID list for each file for storage as a multivalued attribute, together with the file content, in the file system index.

When a user logs on to an enterprise file system and sends a file search query to the enterprise search engine, the query is extended by the SID list of the user. Putting the original query and the SID list together as an extended query, the search engine matches (e.g, using a simple intersect operation) the resolved SID list of the found files with the SID list of the user. Thus, rather than performing an application callback, or using join operations, an authorization check is conducted. Since the SID lists of the files can be resolved at indexing time (prior to receiving the search query), this kind of match can be executed very efficiently at search time, providing enhanced performance. In addition, the search query can be extended using a restricting AND condition. Thus, the power of a content search (e.g., using a text search engine) and an authorization restriction search (e.g., using an attribute search engine) can be dynamically combined for even greater performance.

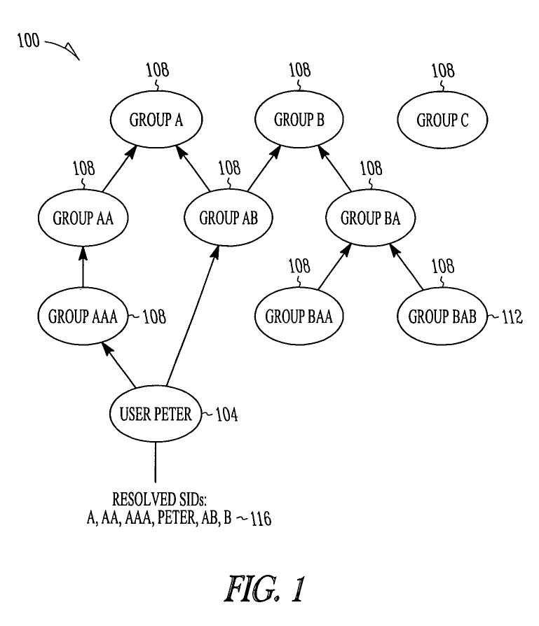

FIG. 1 illustrates the process of security identifier (SID) resolution for users 104 executing secure file searching within a group hierarchy 100 according to various embodiments of the invention. Here it can be seen that an individual user 104 can be assigned to one or more groups 108 (e.g., groups a, b, aa, ab, aaa). In fact, a group 112 can also be assigned to one or more groups 108 (e.g., group bab is assigned to groups b, ba). The hierarchy of users 104 and groups 108 forms a directed acyclic graph (DAG), where each user 104 and each group 108 is identified by at least one SID.

To resolve the list 116 of SIDs for a user 104, the SIDs of its parent goups and their parent groups are added to the list 116 recursively. Duplicate SIDs in the list 116 are removed. When these resolved SID lists 116 are stored prior to searching, the various embodiments can be implemented more efficiently. Global SIDs, which are associated with a domain, may also be assigned.

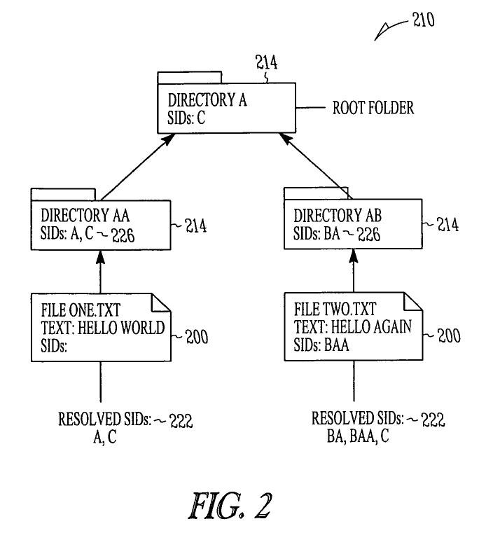

FIG. 2 illustrates the process of security identifier (SID) resolution for files 200 in a file system 210 according to various embodiments of the invention. A file 200 resides in a single directory 214. A directory 214 resides in no more than one parent directory 214. For example, the directories AA and AB reside in the parent directory A. Thus, the hierarchy of files 200 and directories 214 within a file system 210 form a tree with the files 200 as leaves.

Each file 200 and each directory 214 may have one or two lists of SIDs. For example, if two lists of SIDs are used, the lists may include an sid_allowed_list (e.g., comprising SIDs for which access is granted), and an sid_forbidden_list (e.g., comprising SIDs for which access is revoked). A user may therefore get access to a file if at least one of the SIDs in his resolved SID list (e.g., list 116 of FIG. 1) appears in the resolved sid_allowed_list of the file 200, and none of the SIDs in the user's resolved SID list appears in the resolved sid_forbidden_list of the file 200.

The function that determines whether access is granted using these two lists can be expressed by the following formula:

read_access(user, file) =

not(is_empty(intersection(resolved_sid_list(user),

resolved_sid_allowed_list(file)))) AND

is_empty(intersection(resolved_sid_list(user),

resolved_sid_forbidden_list(file)))

For example, in some embodiments, the two SID lists can be implemented as two multivalue attributes in the attribute search engine. For example, if the TREX attribute engine is used, the sid_allowed_list can be implemented as the attribute allowedSID, and the sid_forbidden_list can be implemented as the attribute notAllowedSID. In terms of computation, those of ordinary skill in the art will realize that the sid_forbidden_list can be processed in a similar manner to the sid_allowed_list.

A simpler approach may be used, using a single list of SIDs, such as the sid_allowed_list. If this is the case, then the user can get access to a file 200 if at least one of the SIDs in his resolved SID list appears in the resolved sid_allowed_list of the file 200. Similarly, if the single list used is the sid_forbidden_list, then the user may get access to a file if none of the SIDs in the user's resolved SID list appears in the resolved sid_forbidden_list of the file 200. To simplify the discussion hereafter, the use of only one SID list per file will be described.

To resolve the list 222 of SIDs for a file 200, the SIDs 226 of its parent directories 214 are added to the list 222 recursively. For example, the list 222 for file One.txt is resolved by adding the SIDs 226 of its parent directories AA and A recursively. Likewise, the SID list 222 for file Two.txt is resolved by adding the SIDs 226 of its parents, Directory AB and Directory A, recursively. Duplicate SIDs in the lists 222 are removed. As noted previously, when these resolved SID lists 222 of the files 200 are stored prior to searching (creating previously-resolved SID lists for the files 200), the various embodiments can be implemented more efficiently. If the tree structure of the file system 200 is well-balanced (e.g., for n files the tree has O(log(n)) hierarchy levels, where O is taken from computational complexity theory and used to describe an asymptotic upper bound for the magnitude of a function), search efficiency can further increase as compared to an unbalanced situation.

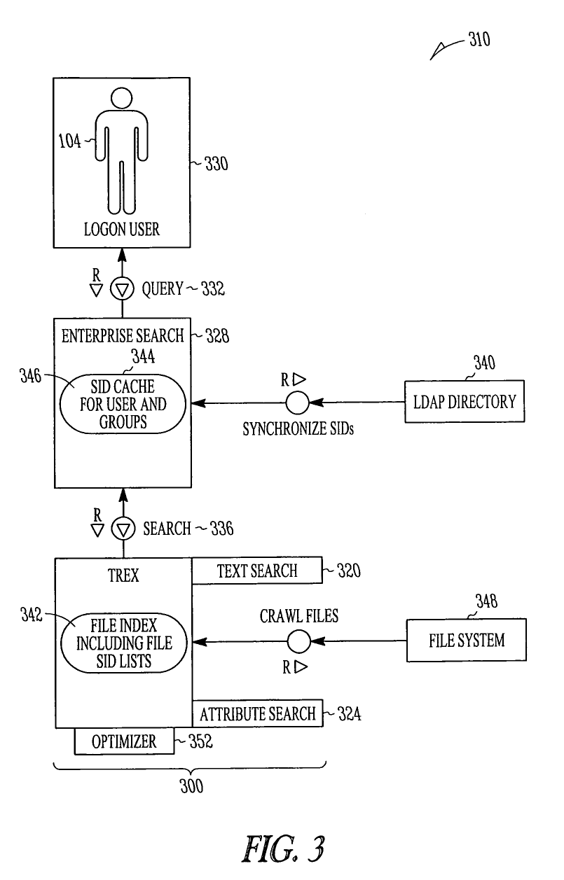

FIG. 3 is a block diagram of an apparatus 300 and system 310 to implement secure file searching according to various embodiments of the invention. It should be noted that while use of the TREX search and classification engine is indicated in the figure, this is only by way of illustration, and not limitation. Any search engine configured to operate as described herein can be used in the place of the search engine 314 shown in FIG. 3.

In many embodiments, the search engine 314 includes a text engine 320 for fast content search based on symbols or characters stored in the files (unstructured content), and an attribute engine 324 for fast search based on attribute values (structured content). For secure file searching with increased efficiency, as described herein, these two engines 320, 324 may be used in combination.

The text engine 320 has a text dictionary. In the text dictionary, each term is maintained in conjunction with a list of all files in the file system containing that term. The text dictionary can provide efficient full text searching using a table lookup function. To further improve performance, the table may be kept in main memory. For example, the table of the text dictionary with respect to the files 200 shown in FIG. 2 might appear as shown in Table I.

TABLE I

| TERM | ASSOCIATED FILES |
|---|---|
| hello | One.txt, Two.txt |
| world | One.txt |
| again | Two.txt |

Within the attribute engine 324 an SID dictionary may be created. For every SID in this SID dictionary, documents having the SID in their resolved list of SIDs are listed. The SID dictionary provides an efficient search for documents associated with SIDs by table lookup. To further improve performance, the table can be kept in main memory. For example, the table of the text dictionary with respect to the files 200 shown in FIG. 2 might appear as shown in Table II.

TABLE II

| SID | ASSOCIATED FILES |
|---|---|
| A | One.txt |
| Ba | Two.txt |
| baa | Two.txt |
| c | One.txt, Two.txt |

For example, consider a user searching for files containing the word “hello”. The enterprise search component 328 operates to extend the query 332 by adding the resolved SID list for that user (e.g., the list 116 for user 104 of FIG. 1). In this case, the extension function might appear as follows: AND(search_term=“hello”,SID=OR(a, aa, aaa, peter, ab, b)).

The search term is sent to the text engine 320. This transmission might appear as: search_result_text(“hello”)=One.txt, Two.txt. The SID list for the user is sent to the attribute engine 324. This transmission might appear as: search_result_SID(SID=OR(a, aa, aaa, peter, ab, b))=One.txt. The final result is determined by applying the AND operation according to the formula: search_result=AND(search_result_text, search_result_SID)=One.txt.

The text search and the authorization restriction are computed within the search engine 314 in a substantially simultaneous fashion. If the search engine feature of query plan optimization is used, an even more efficient search may result.

Prior to executing the search query for the user, the search engine 314 can be used to crawl the file system to index the files. While crawling occurs, the engine 314 operates to fetch, resolve, and store SID lists for each file. The enterprise search component 328 then operates to fetch, resolve, and cache the SID lists for users and groups. Thereafter, when a user 104 logs in to the system, a search request 332 can be entered. The search request 332, including search criteria, is then extended by the SID list for that user. After the text/attribute search is conducted, the resulting matched file list comprises hits (via the intersection operation) that have been authorized for that user and that query.

Thus, many embodiments may be realized. For example, a system 310 may comprise a user interface 330 to receive file search criteria in the query 332 associated with the identity of the user 104. The system 310 may also include an SID storage module 344 (e.g., perhaps including a cache memory 346) to store one or more SIDs associated with the user's identity, as well as a search engine 314 to identify a set of authorized files as an intersection between a first group of files meeting the file search criteria (e.g., resulting from operation of the text search engine 320) and a second group of files (e.g., resulting from operation of the attribute search engine 324), wherein each one of the second group of files is associated with a previously-resolved list 342 of SIDs that includes the SIDs associated with the user identity.

Thus, in some embodiments, the apparatus 300 may comprise a search engine 314 including a text search engine 320 and an attribute search engine 324. The system 310 may comprise a workstation, or client-server installation, among others. For example, the user interface 330 may be included in a client module (e.g., as part of a client workstation), and the search engine 314 may be included in a server module (e.g., as part of a multi-processor server).

The SID storage module 344 may comprise an SID cache 346 coupled to a directory 340 accessible via lightweight directory access protocol (LDAP). Of course, this is only one possible structure that can be used for SID storage.

As noted previously, the search engine 314 may comprise a text search engine 320 to search the first group of files, and an attribute search engine 324 to search the second group of files. In some embodiments, a query optimizer 352, known to those of ordinary skill in the art, may be used to control interaction between the text search engine 320 and the attribute search engine 324. Many more embodiments may be realized.

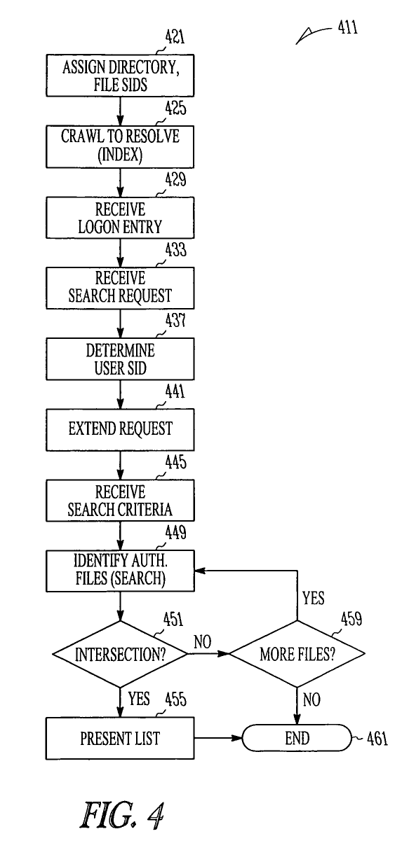

For example, FIG. 4 is a flow diagram illustrating methods 411 of secure file searching according to various embodiments of the invention. The methods 411 are implemented in a machine-accessible and readable medium, and are operational over processes within and among networks. The networks may be wired, wireless, or a combination of wired and wireless. The methods 411 may be implemented as instructions, which when accessed by a machine, perform the processing depicted and described with respect to FIGS. 1-3 and described previously. Given this context, secure file searching is now discussed with reference to FIG. 4.

In some embodiments, a computer-implemented method 411 of secure file searching, or searching for authorized files may comprise assigning SIDs, and begin at block 421 with indirectly assigning one or more SIDs to a file within a file system. The indirect assignment activities at block 421 may include directly assigning the SIDs to one or more directories within the file system. The indirect assignment of an SID to a file occurs when at least one of the directories that has an SID assigned directly to it includes, or has a sub-directory that includes, the file.

The method 411 may go on to block 425 to include crawling a file system that includes indirect assignment of SIDs to files in the file system, to resolve the indirect assignment of SIDs to a direct assignment of the SIDs for the appropriate files. Indexing of the file system may occur at substantially the same time as crawling of the file system (when SIDs for files are resolved). For example, the crawler component may operate to send files to the indexer. The file processing can be done in a pipeline. Thus, while the first file is being indexed, a second file is already being crawled, so that for most of the process, crawling and indexing occur substantially simultaneously.

The method 411 may include, at block 429, receiving a logon entry to establish the identity of a user, such as when a user logs on to a system prior to conducting an authorized search. The search request, including file search criteria, may then be received at block 433.

The method 411 may go on to include, at block 437, determining SIDs for the user by searching for one or more authorization groups which have the identity of the user as a member, and which are already associated with one or more SIDs. In this way, the authorization groups can be used to find the user's authorizing SIDs. Of course, SIDs may also be assigned directly to the user in some embodiments.

The method 411 may include, at block 441, extending the original search request associated with the user's identity to include both the file search criteria and the authorizing SIDs for the user. In this way, the original search request, identified with the user conducting the search, is extended to include the user's resolved SID list.

The method 411 may then go on to include receiving file search criteria associated with the user identity and at least one SID, also associated with the user identity, at block 445.

At this point, authorized files resulting from a search query can be identified. For example, the method 411 may include, at block 449, identifying a set of authorized files as the intersection between a first group of files meeting the file search criteria and a second group of files, wherein each one of the second group of files is associated with a previously-resolved list of SIDs that includes at least one SID associated with the user identity. In this way, the extended search request is received and used to compute the intersection between two groups of files. Due to the crawling and indexing activity, at least one of the file groups can have SID information resolved prior to receiving the extended search request.

The identification activities at block 449 may therefore include searching the first group of files at substantially the same time as the second group of files are searched. This may include searching the first group of files using a text search engine, and searching the second group of files using an attribute search engine, such that both text matching and SID matching are conducted at approximately the same time. In some embodiments, these activities may include searching for text in files included in the file system to match the search criteria, and substantially simultaneously searching for the at least one SID associated with the user identity within a previously-resolved list of SIDs (for the files that have been found).

In some embodiments, the identification activities of block 449 may include identifying the set of authorized files using a non-joined, single table lookup operation. That is, authorized files can be identified using an intersection operation, and without using a join operation, increasing efficiency.

If no intersection between the first and second groups of files is found at block 451, and no more files are to be searched, as determined at block 459, then the method 411 may end at block 461. Otherwise, an attempt may be made to identify other files having an intersection at block 449.

If an intersection is found at block 451, then the method 411 may include, at block 455, presenting the set of authorized files as a viewable list, so that the search results are displayed to the user. The set of authorized files may also be presented as part of a graphical user interface (GUI), such as an interactive GUI.

These are but a few examples of how various embodiments described herein can operate. They are given for purposes of illustration, and not limitation. Thus, many other embodiments may be realized.

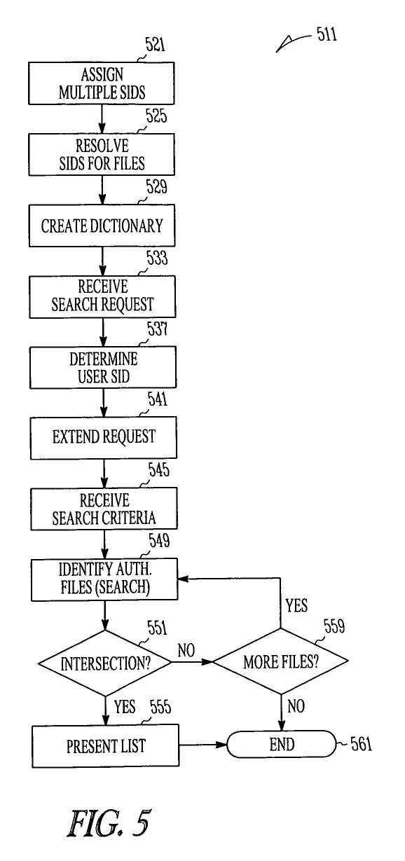

For example, FIG. 5 is a flow diagram illustrating additional methods 511 of secure file searching according to various embodiments of the invention. The methods 511 are implemented in a machine-accessible and readable medium, and are operational over processes within and among networks. The networks may be wired, wireless, or a combination of wired and wireless. The methods 511 may be implemented as instructions, which when accessed by a machine, perform the processing depicted and described with respect to FIGS. 1-4. Given this context, secure file searching is now discussed with reference to FIG. 5.

In some embodiments, a computer-implemented method 511 of preparing a file system for secure file searching may begin at block 521 with assigning at least one access permitted SID and at least one access revocation SID to a directory in a file system. The access permitted SID and access revocation SID may be similar to or identical to those SIDs described with respect to the concept of an sid_allowed_list and sid_forbidden_list, respectively, and discussed previously.

The method 511 may go on to block 525 to include resolving an unresolved list of SIDs for a file in the file system, providing a previously-resolved list of SIDs by recursively adding SIDs associated with at least one parent directory of the directory in which the file resides.

In some embodiments, the method 511 may include creating a dictionary having a plurality of resolved SIDs at block 529, wherein each one of the plurality of resolved SIDs is associated with a number of preselected files in the file system.

The method 511 may go on to include receiving a search request at block 533, and determining at least one SID associated with the user's identity at block 537. The method 511 may go on to block 541 to include extending the original search request, as described previously.

In some embodiments, the method 511 may include, at block 545, receiving file search criteria associated with the user identity and at least one SID associated with the user identity, wherein the at least one SID associated with the user identity is included in a set of resolved SIDs. That is, the activities of block 545 may include receiving the SIDs associated with the user identity as an extension of an original search request that includes file search criteria.

The method 511 may go on to include, at block 549, identifying a set of authorized files as the intersection between a first group of files meeting the file search criteria and a second group of files. One or more of the second group of files may be associated with a previously-resolved list of SIDs that includes the access permitted SID to match the SIDs associated with the user identity. In some embodiments, a check is also made to ensure that none of the set of SIDs resolved for the user matches the access revocation SID. Thus, in some embodiments, two different types of SIDs per file are maintained, as described previously.

The identification activities of block 549 may include searching the dictionary created in block 529 to locate the SIDs associated with the user identity within the plurality of resolved SIDs. These activities may also include searching for text in files included in the file system to match the search criteria, and substantially simultaneously searching for the SIDs associated with the user identity within the previously-resolved list of file SIDs.

If no intersection between the first and second groups of files is found at block 551, and no more files are to be searched, as determined at block 559, then the method 511 may end at block 561. Otherwise, an attempt may be made to identify other files having an intersection at block 549.

If an intersection is found at block 551, then the method 511 may include, at block 555, presenting the set of authorized files as a viewable list, so that the search results are displayed to the user. The set of authorized files may be presented as part of a graphical user interface GUI, including an interactive GUI.

Those of ordinary skill in the art will realize that each of the method elements shown in FIG. 5 may be added to or substituted for any of the method elements shown in FIG. 4. Additionally, those of ordinary skill in the art will also realize that each of the method elements of FIGS. 4-5 may be combined with the other elements shown in a variety of ways, to form a variety of methods that use the elements from each of the figures in serial, parallel, looped, and/or repetitious fashion.

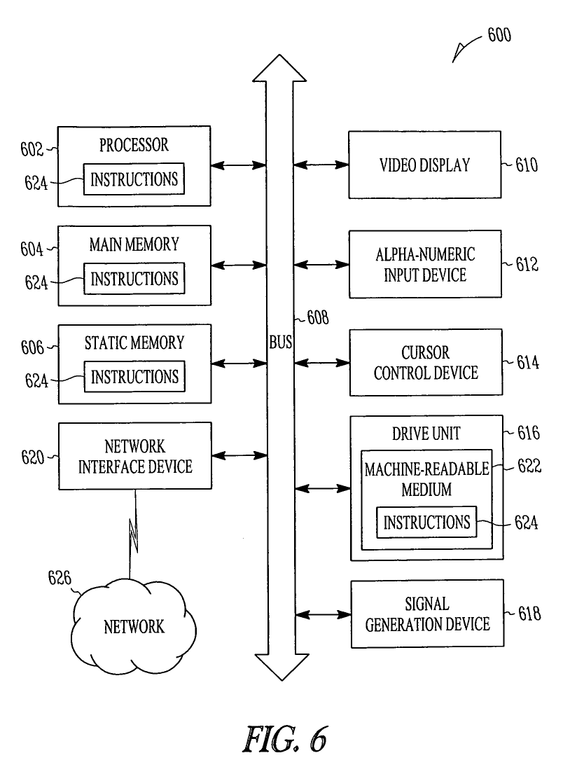

FIG. 6 is a block diagram of a machine in the example form of a computer system 600 according to various embodiments of the invention. The computer system may include a set of instructions 624 for causing the system 600 to perform any one or more of the methodologies discussed herein, including those illustrated in FIGS. 4-5. The system 600 may be similar to or identical to the system 310 of FIG. 3.

In some embodiments, the system 600 may operate as a standalone device or may be connected (e.g., networked) to other machines. In a networked deployment, the system 600 may operate in the capacity of a server or a client machine in a server-client network environment, or as a peer machine in a peer-to-peer (or distributed) network environment.

The system 600 may comprise a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 600 may include a processor 602 (e.g., a central processing unit (CPU), a graphics processing unit (GPU) or both), a main memory 604 and a static memory 606, all of which communicate with each other via a bus 608. The system 600 may further include a video display unit 610 (e.g., liquid crystal displays (LCD) or cathode ray tube (CRT)). The display unit 610 may be used to display a GUI according to the embodiments described with respect to FIGS. 3-5. The system 600 also may include an alphanumeric input device 612 (e.g., a keyboard), a cursor control device 614 (e.g., a mouse), a disk drive unit 616, a signal generation device 618 (e.g., a speaker), and a network interface device 620.

The disk drive unit 616 may include a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the system 600, the main memory 604 and the processor 602 also constituting machine-readable media. The software 624 may further be transmitted or received over a network 626 via the network interface device 620, which may comprise a wired and/or wireless interface device.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the various embodiments. The term “machine-readable medium” shall accordingly be taken to include tangible media that include, but are not limited to, solid-state memories, optical, and magnetic media.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

In conclusion, it can be seen that the secure search mechanisms presented herein may provide increased efficiency by performing an authorization check at substantially the same time as content searching occurs. The performance of two different dynamically optimized searches at substantially the same time is enabled by resolving lists of SIDs for files in the file system at the time of indexing—prior to searching. Therefore, matching of file SID lists with user SID lists can be accomplished using the original query, extended by a restricting AND condition, in conjunction with a simple intersect operation, rather than a less efficient join operation. This type of operation can lead to a significant performance improvement.

Embodiments of the invention can be implemented in a variety of architectural platforms, operating and server systems, devices, systems, or applications. Any particular architectural layout or implementation presented herein is thus provided for purposes of illustration and comprehension only, and is not intended to limit the various embodiments.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer implemented method, comprising:
receiving file search criteria associated with a user identity and at least one security identifier associated with the user identity; and
identifying a set of authorized files as an intersection between a first group of files meeting the file search criteria and a second group of files, wherein each one of the second group of files is associated with a previously-resolved list of security identifiers that includes the at least one security identifier associated with the user identity.

2. The method of claim 1, comprising:
extending an original search request associated with the user identity to include both the file search criteria and the at least one security identifier.

3. The method of claim 1, comprising:
presenting the set of authorized files as a viewable list.

4. The method of claim 1, comprising:
indirectly assigning the at least one security identifier to a file within a file system.

5. The method of claim 4, wherein indirectly assigning comprises:
directly assigning the at least one security identifier to a directory within the file system, wherein the directly has a sub-directory that includes the file.

6. The method of claim 1, comprising:
crawling a file system including indirect assignment of the at least one security identifier to resolve the indirect assignment to a direct assignment of the at least one security identifier to a file included in the file system.

7. The method of claim 6, wherein indexing of the file system occurs at substantially the same time as the crawling of the file system.

8. The method of claim 1, comprising:
receiving a logon entry to establish the user identity.

9. The method of claim 1, comprising:
determining the at least one security identifier by searching for an authorization group associated with the at least one security identifier and having the user identity as a member.

10. The method of claim 1, wherein the identifying comprises:
searching the first group of files at substantially the same time as the second group of files are searched.

11. The method of claim 1, wherein the identifying comprises:
searching the first group of files using a text search engine; and
searching the second group of files using an attribute search engine.

12. A computer implemented method, comprising:
assigning at least one access permitted security identifier and at least one access revocation security identifier to a directory in a file system;
receiving file search criteria associated with a user identity and at least one security identifier associated with the user identity, wherein the at least one security identifier associated with the user identity is included in a set of resolved security identifiers; and
identifying a set of authorized files as an intersection between a first group of files meeting the file search criteria and a second group of files, wherein each one of the second group of files is associated with a previously-resolved list of security identifiers that includes the access permitted security identifier to match the at least one security identifier associated with the user identity, and wherein none of the set of resolved security identifiers matches the access revocation security identifier.

13. The method of claim 12, wherein the receiving comprises:
receiving the at least one security identifier associated with the user identity as an extension of an original search request including the file search criteria.

14. The method of claim 12, comprising:
resolving an unresolved list of security identifiers for a file in the file system to provide the previously-resolved list of security identifiers by recursively adding security identifiers associated with at least one parent directory of the directory which the file resides.

15. The method of claim 12, comprising:
creating a dictionary having a plurality of resolved security identifiers, wherein each one of the plurality of resolved security identifiers is associated with a number of preselected files in the file system.

16. The method of claim 15, comprising:
searching the dictionary to locate the at least one security identifier associated with the user identity within the plurality of resolved security identifiers.

17. The method of claim 12, comprising:
searching for text in files included in the file system to match the search criteria; and
substantially simultaneously searching for the at least one security identifier associated with the user identity within the previously-resolved list of security identifiers.

18. A computer readable medium having instructions stored therein for causing a computer to implement a method, comprising:
receiving file search criteria associated with a user identity and at least one security identifier associated with the user identity; and
identifying a set of authorized files as an intersection between a first group of files meeting the file search criteria and a second group of files, wherein each one of the second group of files is associated with a previously-resolved list of security identifiers that includes the at least one security identifier associated with the user identity.

19. The medium of claim 18, wherein the method comprises:
identifying the set of authorized files using a non-joined, single table lookup operation.

20. The medium of claim 18, wherein the method comprises:
presenting the set of authorized files as part of a graphical user interface.

21. A system, comprising:
a user interface to receive file search criteria associated with the user identity;
a security identifier storage module to store at least one security identifier associated with the user identity; and
a search engine to identify a set of authorized files as an intersection between a first group of files meeting the file search criteria and a second group of files, wherein each one of the second group of files is associated with a previously-resolved list of security identifiers that includes the at least one security identifier associated with the user identity.

22. The system of claim 21, wherein the user interface is included in a client module, and wherein the search engine is included in a server module.

23. The system of claim 21, wherein the security identifier storage module comprises:
a security identifier cache coupled to a directory accessible via lightweight directory access protocol.

24. The system of claim 21, wherein the search engine comprises:
a text search engine to search the first group of files; and
an attribute search engine to search the second group of files.

25. The system of claim 24, comprising:
a query optimizer to control interaction between the text search engine and the attribute search engine.
